(19) United States
(12) Patent Application Publication
(10) Pub. No.: US 2022/0198303 A1
(43) Pub. Date: Jun. 23, 2022

(54) DEVICE, METHOD AND PROGRAM FOR ENVIRONMENTAL FACTOR ESTIMATION, LEARNED MODEL AND RECORDING MEDIUM

(71) Applicant: RIKEN, Wako-shi, Saitama (JP)

(72) Inventors: Kengo ITO, Wako-shi, Saitama (JP); Jun KIKUCHI, Wako-shi, Saitama (JP); Tomoko MATSUMOTO, Wako-shi, Saitama (JP); Taiga ASAKURA, Wako-shi, Saitama (JP); Atsushi KUROTANI, Wako-shi, Saitama (JP)

(73) Assignee: RIKEN, Wako-shi, Saitama (JP)

(21) Appl. No.: 17/603,894

(22) PCT Filed: Apr. 14, 2020
(86) PCT No.: PCT/JP2020/016472

§ 371 Date: Oct. 14, 2021

(30) Foreign Application Priority Data
Apr. 15, 2019 (JP) 2019-077300

(51) Int. Cl. G06N 5/04; G06N 5/02

(52) U.S. Cl. CPC G06N 5/04; G06N 5/022

(57) ABSTRACT

Provided is an environmental factor prediction device that includes a predictor and predicting means. The predictor uses, as explanatory variables: water quality data in a plurality of layers in water, the data including a value corresponding to a biochrome level or a bioluminescence level (e.g. chlorophyll concentration), water temperature, salt concentration, dissolved oxygen, turbidity and flow rate; and meteorological data including atmospheric temperature, precipitation and sunshine duration, and outputs an estimated value of each item of the explanatory variables at a unit time later, based on time series data of the explanatory variables. The predicting means predicts the water quality data up to an N unit time later by repeating prediction using the estimated value acquired by the predictor as input of the predictor again. According to the present invention, the environmental factors that cause generation of red tide, blue tide or water bloom, diseases of fish, and the like, can be predicted, on a long term basis and at high accuracy.

### TECHNICAL FIELD

The present invention relates to a technique to predict environmental factors, and more particularly to a technique to predict environmental factors in water related to the generation of red tide, blue tide, water bloom, disease of fish, and the like.

### BACKGROUND ART

Since the generation of red tide (abnormal growth of plankton and bacteria) causes enormous damage to the marine industry, various red tide prediction methods have been attempted. Particularly in recent years, a variety of red tide prediction methods have been proposed as computers, simulation, artificial intelligence (AI) and IoT related techniques have advanced.

According to a method of NPL 1, an environment factor optimum index model is created for each one of water quality and meteorological data observed in Ise Bay in real-time, and the product thereof is determined, whereby a habitat optimum index is calculated and red tide is predicted. In this method, red tide on the next day is predicted but generally it is preferable to predict the generation of red tide at least three days before. Further, in this method, the hitting ratio and the prediction ratio are 59.4% and 69.5% respectively which are insufficient.

According to a method of NPL 2, the red tide biomass is predicted by machine learning combining linear analysis or non-linear analysis, and prediction at a higher accuracy is possible compared with conventional methods. In NPL 2, only marine information is handled in the analysis. Generally in the prediction of environmental factors, chlorophyll concentration is often predicted, but in NPL 2, the prediction accuracy of the chlorophyll concentration seems insufficient. Another problem is that the relevance between the red tide biomass, i.e., the prediction target used here instead of chlorophyll concentration, and the generation of red tide and definition thereof are not clear.

In the method of NPL 3, chlorophyll concentration in the future is predicted by applying a chaos recurrent neural network to the time series data of the chlorophyll concentration. However, the prediction accuracy acquired here is insufficient.

Further, in addition to the red tide, it is also desirable to predict the environment in water related to blue tide, water bloom, disease of fish, and the like.

### CITATION LIST

### Non Patent Literature

[NPL 1] Yoji Tanaka; Yuna Sugimoto: Real time phytoplankton bloom prediction model by using automatic water quality measurement system in Ise Bay, Journal of Japan Society of Civil Engineers, B3 (Ocean Development), 2016, 72.2: I #970-I #975
[NPL 2] Qin Mengjiao; Li Zhihang; Du Zhenhong: Red tide time series forecasting by combining ARIMA and deep belief network, Knowledge-Based Systems, 2017, 125, pp. 39˜52
[NPL 3] Masayoshi Harada, Akifumi Douma, Kazuaki Hiramatsu, Atsushi Marui: Short-term Prediction of Chlorophyll-a Time Series using Recurrent Neural Network with Periodic Chaos Neurons, 2012, Annual Conference of Japan Society of Irrigation, Drainage and Rural Engineering, September 2012

### SUMMARY OF INVENTION

### Technical Problem

It is an object of the present invention to predict the environmental factors that cause the generation of red tie, blue tide, water bloom, disease of fish, and the like, on a long term basis and at a high accuracy.

### Solution to Problem

An environmental factor prediction device of the present invention includes: a predictor that uses, as explanatory variables, water quality data in a plurality of layers in water, the data including a value corresponding to a biochrome level or a bioluminescence level, water temperature, salt concentration, dissolved oxygen, turbidity and flow rate, and meteorological data including atmospheric temperature, precipitation and sunshine duration, and that outputs an estimated value of each item of the explanatory variables at a unit time later, based on time series data of the explanatory variables; predicting means for predicting the water quality data up to an N unit time later (N is 2 or greater integer) by repeating prediction using the estimated value acquired by the predictor as input of the predictor again.

In this disclosure, “red tide” refers to phenomena in which the color of water changes considerably due to the abnormal growth of microorganisms living in sea water, particularly photosynthetic microorganisms and chemosynthetic microorganisms such as plankton and bacteria, and includes not only red tide in a narrow sense but also white tide and green tide. Further, in the present disclosure, “water bloom” refers to phenomena in which microorganisms living in fresh water, particularly microalgae, grow abnormally. Further, in the present disclosure, “blue tide” refers to phenomena in which anoxic water masses, generated by the decomposition of dead plankton and bacteria which have mass-propagated, and rise to the vicinity of the water surface. In the present disclosure, “plankton” includes both phytoplankton and zoo plankton. The chemosynthetic microorganisms include heterotrophic microorganisms, such as noctilucae. Furthermore, in the present disclosure, diseases of fish are classified into bacteria (e.g. vibrio), viruses (e.g. carp herpes) and other protoctists, for example, which eventually become pathogens in fish.

The values corresponding to the biochrome level and the bioluminescence level are concentration, absorbance, flourescence, and the like. Examples of biochrome are chlorophyll, carotene, xanthophyll (e.g. lutein, fucoxanthin) and phycobilin (e.g. phycocyanin, phycoerythrin). An example of bioluminescence is luminescence caused by the chemical reaction of luciferin-luciferase. By measuring the absorbance, qualitative and quantitative analysis can be performed on the biological samples of nucleic acid constituted of DNA and RNA, protein, and the like, thereby the total amount of bacteria, viruses, protoctists and the like in water can be analyzed qualitatively and quantitatively. The biochrome level and the bioluminescence level are examples of the environmental factors that generate red tide, blue tide, water bloom, and the like.

The viruses that infect a species to form red tide and the like (e.g. Heterosigma akashiwo virus (HaRNAV), HcRNAV, HcDNAV) are confirmed to be related to the end phenomena of red tide and the like, hence these viruses are included as one of the end factors of red tide and the like.

The water quality data includes data on the above mentioned items for 3 layers (upper layer, intermediate layer, lower layer) in water, for example. The water quality data, however, may include data on the above mentioned items for 2 layers or for 4 or more layers in water. The water quality data may be data on sea water or data on fresh water, depending on the purpose of prediction.

The predictor outputs an estimated value at a unit time later of each item of the time series data to-be-inputted. The unit time may be arbitrarily set in accordance with the system request, and may be set to 1 hour, 6 hours or 1 day (24 hour), for example. The above mentioned N is a 2 or greater integer, and may be a value that the N unit time becomes 3 days or more, preferably 7 days or more, or even more preferably 30 days or more. If the explanatory variables have missing values, the estimated value may be calculated by interpolating the missing values.

According to the above configuration, the predictor outputs an estimated value at a unit time later for each item of all the explanatory variables to-be-inputted, hence this estimated value is recursively inputted to the predictor, and a next estimated value at a unit time later can be acquired. By repeating this recursive prediction, the environmental factors, including chlorophyll concentration, can be predicted on a long term basis and at a high accuracy.

The environmental factor prediction device according to this aspect may further include forecasting means for forecasting generation of red tide, blue tide or water bloom, based on the chlorophyll concentration predicted by the predicting means. The forecasting means may forecast the start and/or end of red tide. The forecasting means may forecast the start and/or end of blue tide. And the forecasting means may forecast the start and/or end of water bloom. To determine the start and end of the generation of red tide, blue tide and water bloom, the criterion values of the chlorophyll concentration which are officially released by public institutions (e.g. Tokyo Metropolitan Government Bureau of Environment), fishery research and education institutions, university research institutions or private institutions may be used. The criterion values corresponding to planktonic species and bacterial species have also been officially released, hence in a case where prediction is performed using the later mentioned microorganism data, the start and end of the generation of red tide and the like may be determined using the criterion values corresponding to the dominant planktonic species or the dominant bacterial species.

The predictor of the present aspect may receive sampling data acquired by sampling a water sample, as the explanatory variables, and predict the microorganism data at a unit time later. An example of the sampling data is microorganism data related to the microorganisms contained in water. Examples of the microorganism data are qualitative or quantitative (ratio) data of plankton (18S rRNA gene region, 18S rRNA gene sequence) and bacteria (16S rRNA gene region, 16S rRNA gene sequence) acquired by the PCR amplicon technique, and the qualitative or quantitative (population) data of algae, visually observed using a microscope. Another example of the sampling data is qualitative or quantitative organic substance data or inorganic substance data of an organic substance or inorganic substance in the hydrosphere based on the NMR analysis or ICP analysis. By using the microorganism data for the sampling data, the forecasting means can also forecast the dominant planktonic species and the dominant bacterial species in red tide, blue tide or water bloom to-be-generated.

The predicting means according to this aspect may correct estimated values of the meteorological data or water quality data, which are acquired from the predictor, based on meteorological forecasting data or water quality forecasting data, which is acquired via simulation that is different from the predictor, and which are then inputted to the predictor.

In the present aspect, the meteorological data may include wind velocity. The wind velocity influences the flow rate in water, hence by considering the wind velocity, prediction can be performed at a high accuracy.

In the present aspect, the predictor may be learned by machine learning. An example of the machine learning is a recurrent neural network (RNN), such as the simple RNN, the long short-term memory (LSTM), and the gated recurrent unit (GRU). A type of algorithm of the machine learning is arbitrary, as long as an estimated value of each item at a unit time later can be outputted based on the time series data of the above mentioned explanatory variables, whereby the environmental factors can be predicted as intended in the present invention. Besides the recurrent neural network, reinforcement learning or the like may be used. The learned model may be reconstructed by the transfer learning. The predictor may be a commonly used simulator, for example, instead of the predictor learned by machine learning.

The present invention may be regarded as an environmental factor prediction method for a computer to execute the above mentioned processing. In other words, another aspect of the present invention is an environmental factor prediction method executed by a computer, including: a first step of acquiring the time series data of explanatory variables, which are water quality data in a plurality of layers in water, the data including a value corresponding to a biochrome level or a bioluminescence level, water temperature, salt concentration, dissolved oxygen, turbidity and flow rate, and meteorological data including atmospheric temperature, precipitation and sunshine duration; a second step of acquiring an estimated value of each item of the explanatory variables at a unit time later of the time series data acquired in the first step, using a predictor to output the estimated value of each item of the explanatory variables at a unit time later, based on the time series data of the explanatory variables; and a third step of predicting the water quality data up to an N unit time later by repeating the processing in the second step using the estimated value acquired in the second step as input of the predictor again.

The present invention may also be regarded as a program that causes a computer to execute the above mentioned method. Further, the present invention, may be regarded as a learned model to execute the above mentioned method. Furthermore, the present invention may be regarded as a computer-readable storage medium storing the program or the learned model.

### Advantageous Effects of Invention

According to the present invention, environmental factors that cause the generation of red tide, blue tide, water bloom, diseases of fish, and the like can be predicted on a long term basis and at a high accuracy.

### BRIEF DESCRIPTION OF DRAWINGS

FIG. 1 is a diagram depicting an overview of prediction according to the present embodiment.

FIG. 2 is a functional block diagram of a learning device to learn a predictor.

FIG. 3 is a functional block diagram of a red tide prediction device according to an embodiment.

FIG. 4 is a flow chart of a red tide prediction processing in the red tide prediction device according to an embodiment.

FIG. 5 is a functional block diagram of a red tide prediction device according to another embodiment.

FIG. 6 is a flow chart of the red tide prediction processing in the red tide prediction device according to another embodiment.

FIG. 7 is a graph for describing the learning result of the predictor according to an example (Analysis Example 1).

FIG. 8 is a graph for describing the result of long term prediction using the predictor according to the example (Analysis Example 1).

FIG. 9 is a graph indicating another case of the learning result and long term prediction result using the predictor according to the example (Analysis Example 2).

FIG. 10 is a graph indicating marine sampling data in which missing values are interpolated (Analysis Example 3).

FIG. 11 is a graph indicating another case of the learning result and long term prediction result using the predictor according to the example (Analysis Example 3).

FIG. 12 is a diagram indicating a comparison evaluation result of missing value interpolation methods.

FIG. 13 is a diagram for describing the result of prediction by a predictor generated using transfer learning.

FIG. 14 is a diagram for describing the result of long term prediction that is performed including data acquired by external simulation.

### DESCRIPTION OF EMBODIMENTS

### Embodiment 1

Embodiments of the present invention will be described with reference to the drawings, but the present invention is not limited to the embodiments. Composing elements of each embodiment which will be described herein below may be combined when necessary. In the following embodiments, sea water data is handled as target data to predict the generation of red tide. In the case of predicting the generation of blue tide as well, sea water data is handled as target data. And in the case of predicting the generation of water bloom, fresh water data is handled as target data.

As a species that generates red tide, plankton, belonging to diatoms, Raphidophytes, Gonyaulaxes, Cryptomonads, ciliates, and the like, are known. All of these plankton contain chlorophyll-a and chlorophyll-c. In the present embodiment, concentration of chlorophyll-a and/or chlorophyll-c, among chlorophylls, is selected as an explanatory variable, whereby the start or end of red tide is forecasted.

The commonly known dominant species of red tide are: a species of diatoms, such as Skeletonema spp., Thalassiosira spp., Eucampia spp., Rhizosolenia spp. and Chaetoceros spp.; a species of Raphidophytes, such as Heterosigma spp. and Chattonella spp.; a species of Gonyaulaxes, such as Prorocentrum spp., Ceratium spp., Noctilluca spp. (Noctilluca scintillans), and Karenia spp.; a species of Cryptomonads, such as Chroomonas spp.; and a species of ciliates, such as Mesodinium spp. (Mesodinium rubrum).

In the present embodiment, in addition to the concentration of chlorophyll-a and/or chlorophyll-c, microorganism data may be used as additional explanatory variables to predict environmental factors, to forecast the dominant planktonic species and the dominant bacterial species in red tide of which generation is expected. The microorganism data used here is qualitative and quantitative (ratio) data of the 18S rRNA gene sequence specific to Eukaryote, such as the above mentioned diatoms, Raphidophytes, Gonyaulaxes and/or Cryptomonads.

When blue-green algae (cyanobacteria) and green algae (chlorella, chlamydomonas or the like) become dominant, water bloom is generated. In the case where blue-green algae is dominant, a large amount of chlorophyll-d and chlorophyll-f is most likely to-be-contained in the environment. Therefore if the concentration of chlorophyll-d and/or chlorophyll-f is selected among chlorophylls as the explanatory variable to predict environmental factors, the start or end of water bloom can be forecasted.

The qualitative and quantitative (ratio) data of the 16S rRNA gene sequence specific to cyanobacteria (Prokaryote) may be used for the explanatory variable in the microorganism data, in addition to the concentration of chlorophyll-d and the concentration of chlorophyll-f, then the bacterial species that cause water bloom, for which generation is predicted, can be forecasted.

Some types of cyanobacteria, such as Trichodesminum spp., known as a colony-forming blue-green algae, cause red tide. Therefore the concentration of chlorophyll-d and/or chlorophyll-f may be selected as the explanatory variable to forecast the start or end of the generation of red tide.

The qualitative and quantitative (ratio) data of the 16S rRNA gene sequence unique to cyanobacteria may be used for the explanatory variable as the microorganism data, in addition to the concentration of chlorophyll-d and the concentration of chlorophyll-f, then the bacterial species that cause red tide, of which generation is predicted, can be forecasted.

Further, data on quantitative values or the like of viruses related to the end phenomena that infect the red tide generating species (e.g. Heterosigma akashiwo virus (HaRNAV), HcRNAV, HcDNAV) may be used for the explanatory variables, in addition to the concentration of chlorophyll-d and the concentration of chlorophyll-f, then the end of red tide can be forecasted. The quantitative values of these viruses are acquired by measuring absorbance or the like, and are equivalent to the values corresponding to the biochrome level or the bioluminescence level.

<Overview>

A case of predicting the generation of red tide on a long term basis will be described as an example. Critical in long term prediction of red tide generation is not predicting red tide generation for one week later or one month later, but predicting red tide generation for one day later or one hour later. This is because a phenomenon that occurs immediately before the generation of red tide has a strong influence on a phenomena that occurs next, and the prediction accuracy decreases as the time to predict is in a more distant future. Therefore it is important to establish a method to accurately predict the phenomena in the immediate future, and if this method is established, it becomes possible that the predicted values on a short term basis are applied to the prediction model and the next predicted values are calculated again, and by repeating this process, the next long term prediction at high accuracy becomes possible.

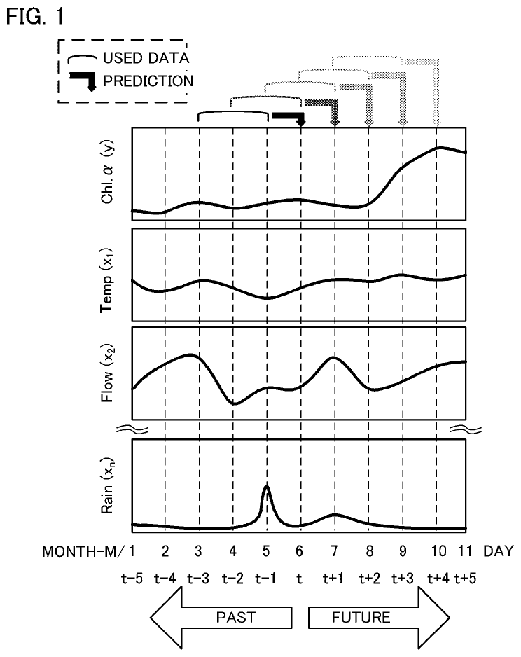

In the present invention, as indicated in FIG. 1, a predicted value of each item at a unit time later is estimated from the time series data of observing water quality and meteorological data, including the chlorophyll-a concentration, based on the regressive prediction using a predictor. The predictor determines an estimated value of each item for one day later, for example, using 3 days of chlorophyll-a concentration, water temperature, atmospheric temperature and the like for each day as input data. Then by recursively inputting each estimated value to the predictor, the chlorophyll-a concentration can be predicted on a long term basis. Then based on the long term prediction of the chlorophyll-a concentration, the start and end of the generation of red tide can be predicted.

<Learning of Predictor>

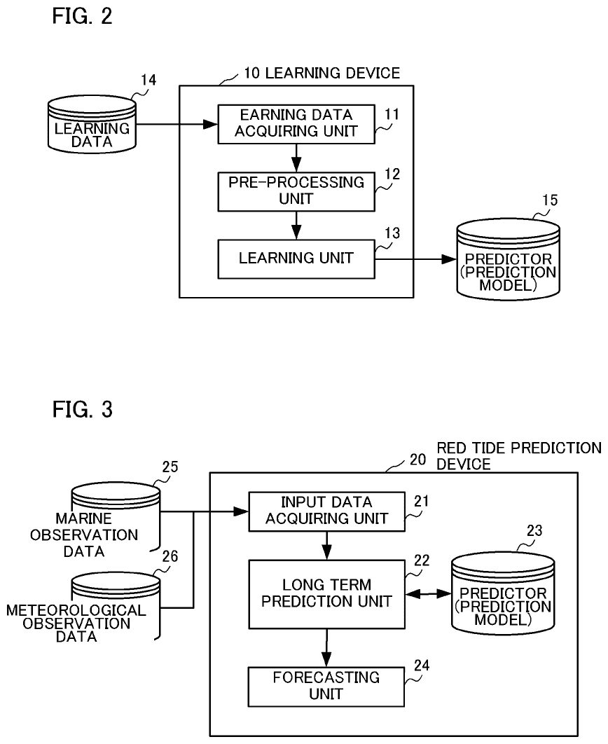

FIG. 2 indicates a configuration of a learning device 10 to learn a predictor. The learning device 10 includes a learning data acquiring unit 11, a pre-processing unit 12, and a learning unit 13, as functional units. The learning device 10 is a computer (information processing device) that includes an arithmetic processor, a storage device, an input device, an output device, a communication device, and the like, and these functions are implemented by the arithmetic processor executing a program.

The learning data acquiring unit 11 acquires learning data that is used for learning the predictor 15. Explanatory variables that are used for the learning data are roughly divided into marine data (water quality data) and meteorological data.

The marine data includes chlorophyll-a concentration, water temperature, salt concentration, dissolved oxygen amount, turbidity and flow rate. The marine data may also include pH data. Here the chlorophyll-a concentration is used as the chlorophyll concentration, but other chlorophyll concentration data, such as chlorophyll-b concentration, chlorophyll-c concentration, chlorophyll-d concentration, chlorophyll-e concentration and chlorophyll-f concentration, may be used, instead of or in addition to chlorophyll-a concentration. Further, the concentration of bacterio chlorophylls-a, -b, -c, -d, -e, -f, -g and the like may be used. Chlorophyll is an example of biochrome, and the concentration of other biochromes, such as carotenes, xanthophylls (e.g. lutein, fucoxanthin), and phycobilins (e.g. phycocyanin, phycoerythrin), may be used. Instead of chlorophyll concentration, absorbance or fluorescence may be used as the explanatory variables. This is the same for the other biochromes. Instead of or in addition to the chlorophyll concentration, bioluminescence may be used as the explanatory variable. For example, the luminescence level generated by the chemical reaction of luciferin-luciferase in noctilucae can be used. The marine data may be directly measured by sampling sea water or by installing a sensor in sea water, or may be remotely acquired using a satellite-based hyper-spectral sensor. In the latter, the horizontal distance in the upstream direction or downstream direction, with respect to the direction of water flow, can be included as a prediction factor.

The meteorological data includes atmospheric temperature, precipitation and sunshine duration. The meteorological data may also include atmospheric pressure, wind velocity, humidity and cloud cover.

These observation values of the marine data and the meteorological data are periodically observed and published by such public institutions as the Japan Meteorological Agency and The Tokyo Bay Environmental Information Center, hence the learning data acquiring unit 11 may acquire these observation values. Data that is published by other institutions, such as by private companies, or data that is directly observed, may also be used.

Besides the above learning data, microorganism data acquired by experiment using samples (sea water) sampled from the sea, may be added. For example, qualitative and quantitative (ratio) data of plankton (18S rRNA gene region, 18S rRNA gene sequence) and bacteria (16S rRNA gene region, 16S rRNA gene sequence) in the sea water, based on the PCR amplicon sequence technique, may be added. Further, qualitative and quantitative data on the marine organic substances and inorganic substances in the sea water based on NMR analysis or ICP analysis, may be added. Furthermore, qualitative and quantitative data (population) data of algae, based on visual observation using a microscope, may be added.

Forecasting data based on meteorological and marine simulations may be used for the marine data and the meteorological data. For example, data on global atmospheric air acquired using the global spectral model (GSM), such as atmospheric pressure, wind velocity, wind capacity, wind direction, temperature, humidity, precipitation, cloud cover, amount of solar radiation (downward shortwave radiation) and the amount of infrared radiation (downward longwave radiation) may be used. Each of the above data on the air of a forecasting target region acquired using the Meso scale model(MSM), instead of the global spectral model, may be used. Further, such data as ocean current, water temperature and salt concentration of global sea water, acquired using an oceanic general circulation model (e.g. regional ocean modeling system (ROMS)), may be used. Further, forecasting data based on a model integrating atmosphere and ocean may be used.

Furthermore, chlorophyll concentration, water temperature, salt concentration, dissolved oxygen amount, turbidity, flow rate and the like, acquired using a river inflow model, may be used.

The pre-processing unit 12 performs the outlier processing, missing value interpolation, data interpolation and normalization. The pre-processing unit 12 removes or interpolates an outlier and a missing value as required. For interpolation, the k nearest neighbor algorithm, MissForest, or values based on a median value, a mean value or like, may be used. Interpolating a missing value is particularly effective in a case where the data is periodic, or where the data does not fluctuate very much. Normalization is a processing to make the maximum value 1 and the minimum value 0, for example. The pre-processing unit 12 may performs discretization processing to convert continuous data into discrete data, or may perform data compression processing (eigenvalue decomposition) as required.

The learning unit 13 learns for a predictor (prediction model) 15, which determines an estimated value for one day later of each explanatory variable included in input data, from observation time series data for a predetermined number of days (e.g. 3 days). Since prediction is performed based on the time series data, a recurrent neural network (RNN), such as simple RNN, long short-term memory (LSTM) and gated recurrent unit (GRU), may be used for the predictor 15. For an algorithm of the machine learning, any type of algorithm can be used, as long as an estimated value of each item at a unit time later is outputted based on the time series data of explanatory variables, and the intended environmental factor can be predicted as the effect of the present embodiment. Besides the recurrent neural network, reinforcement learning or the like may be used. The learned model may be reconstructed by transfer learning. The predictor may be a commonly used simulator, for example, instead of a predictor learned by machine learning.

<Prediction of Red Tide Generation>

FIG. 3 indicates a configuration of a red tide prediction device 20 according to an embodiment, that predicts the generation of red tide. The red tide prediction device 20 includes an input data acquiring unit 21, a long term prediction unit 22, a predictor 23 and a forecasting unit 24 as functional units. The red tide prediction device 20 is a computer (information processing device) that includes an arithmetic processor, a storage device, an input device, and output device, a communication device, and the like, and these functions are implemented by the arithmetic processor executing a program.

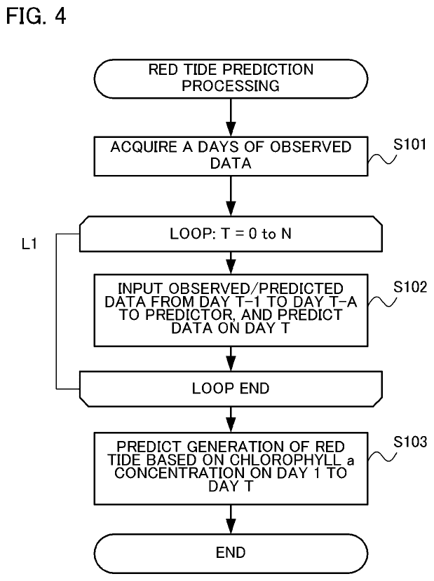

FIG. 4 is a flow chart indicating a flow of the red tide prediction processing performed by the red tide prediction device 20. The red tide prediction device 20 will be described with reference to FIG. 3 and FIG. 4. In the present configuration example, it is assumed that the predictor 23 has been learned based on marine observation data and meteorological observation data.

First, in step S101, the input data acquiring unit 21 acquires the latest A number of days (predetermined number of days) of observed data at a point where red tide generation is predicted. Here marine observation data 25 and meteorological observation data 26 for 3 days (A=3) are acquired.

In a loop L1, the long term prediction unit 22 inputs the latest A number of days of data to the predictor 23, to predict data for the next day, and returns this result to the predictor 23 again. By repeating these steps, the long term prediction unit 22 predicts the data up to day N. Specifically, A=3 is set, and the data on day T is predicted from the observed data from day T−1 to day T−3, the data on day T+1 is predicted from the predicted date on day T and the observed data on day T−1 and day T−2, and the data on day T+2 is predicted from the predicted data on day T+1 and day T and the observed data on day T−1. By repeating this, data up to day N can be predicted. Here N is an arbitrary value of a 2 or greater integer, and is N=30, for example.

When prediction up to day N completes, the forecasting unit 24 predicts the start and end of the generation of red tide in step S103, based on the chlorophyll-a concentration up to N days later. To determine the start and end of the generation of red tide, the criterion values based on chlorophyll-a concentration, released by such a public institution as The Tokyo Metropolitan Government Bureau of Environment, may be used, for example.

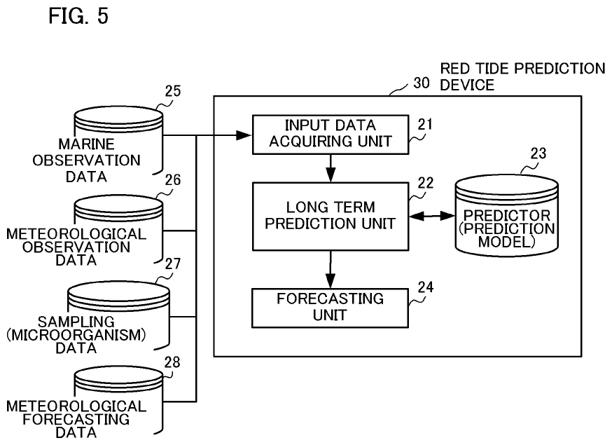

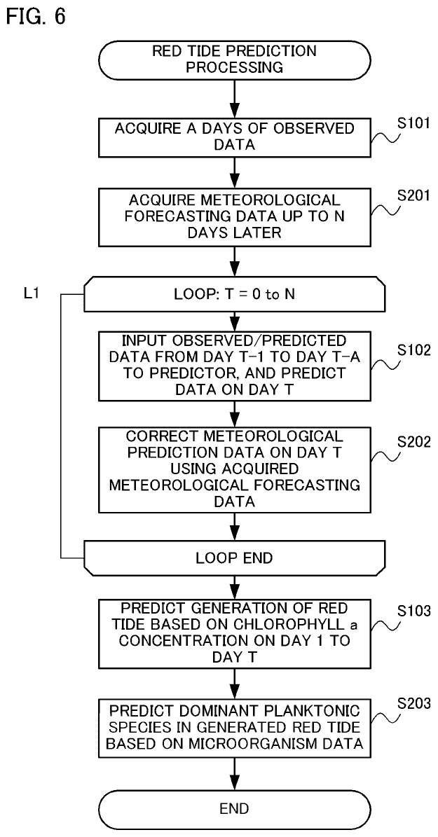

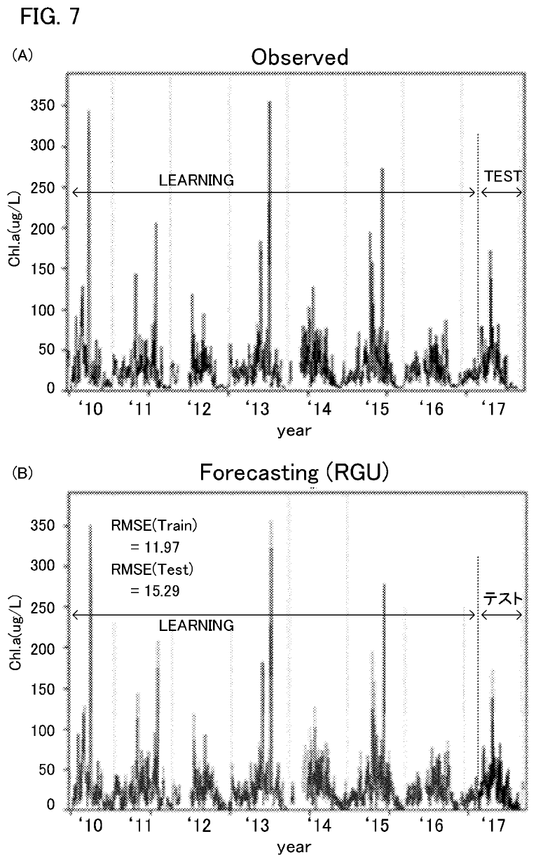

FIG. 5 indicates a configuration of a red tide prediction device 30 according to another embodiment. FIG. 6 is a flow chart indicating a flow of the red tide prediction processing performed by the red tide prediction device 30 according to the present configuration example. A composing element or a processing step the same as above is denoted with a same reference sign.

A difference from the above mentioned configuration (FIG. 3) is that the red tide generation is predicted using microorganism sampling data 27 and meteorological prediction data 28 as well. In the present configuration example, it is assumed that the predictor 23 has been learned based on the marine observation data, meteorological observation data, microorganism sampling data and meteorological forecasting data.

The input data acquiring unit 21 acquires A number of days of the marine observation data 25, meteorological observation data 26, and microorganism sampling data 27 in step S101. The input data acquiring unit 21 also acquires the meteorological forecasting data up to N days later in step S201. The meteorological forecasting data is simulation data targeting the global atmosphere, such as atmospheric pressure, wind velocity, wind capacity, wind direction, temperature, humidity, precipitation, cloud cover, amount of solar radiation, and the like, acquired based on a global spectral model (GSM).

In the processing steps in a loop L1, the long term prediction unit 22 inputs the marine observation data, meteorological observation data and sampling data to the predictor 23 to predict the data on one day later, and returns this result to the predictor 23 again, which is the same as the above mentioned embodiment. However, in step S202, the long term prediction unit 22 corrects the meteorological data, which is predicted by the predictor 23, based on the acquired meteorological forecasting data, and inputs the corrected data to the predictor 23 again. A specific correction method here is arbitrary, and may be determined as an average or as a weighted mean. By correcting the predicted value of the meteorological data like this first and then returning the corrected data to the predictor 23, a more accurate prediction can be implemented. For the marine observation data (water quality data) 25 as well, the marine data (water quality data) predicted by the predictor 23 may be corrected using the predicted data based on simulation first, and then the corrected data may be inputted to the predictor 23 again.

In step S103 up to N days later, the forecasting unit 24 predicts the start and end of the generation of red tide based on the chlorophyll-a concentration up to N days later. Further, the forecasting unit 24 predicts the dominant planktonic species and dominant bacterial species in the red tide to-be-generated, based on the predicted values of the microorganism sampling data in the period when the generation of red tide is predicted. The forecasting unit 24 may predict the start and end of the generation of red tide using criteria in accordance with the dominant planktonic species or dominant bacterial species (e.g. “500 cells/ml or more” in a case where Karenia species is the dominant species). In the present configuration example, the microorganism sampling data is also used, hence the generation of red tide can be predicted using the prediction of the dominant planktonic species and dominant bacterial species, and criteria in accordance with the dominant planktonic species and dominant bacterial species.

### ANALYSIS EXAMPLE b 1

As an example of red tide prediction, the prediction of chlorophyll-a concentration was attempted as an index of red tide generation, targeting inner Tokyo Bay (off the coast of Urayasu). For the meteorological observation data in real-time, the hourly sunshine duration and precipitation, observed at the Edogawa Rinkai Station, was acquired from the web site of The Japan Meteorological Agency, and the average and total thereof of each day were calculated. For the marine observation data in real-time, data in the upper layer, intermediate layer and lower layer of the ocean, on the chlorophyll-a concentration, water temperature, salt concentration, dissolved oxygen amount, turbidity, and flow rate (flow velocity), and data on air capacity (wind velocity), which were observed off the coast of Urayasu every hour, were acquired from the web site of The Tokyo Bay Environmental Information Center, and the average and total thereof of each day were calculated.

Specific explanatory variables used in the present example are the following 52 items.

### [Marine Data]

Chlorophyll a concentration (upper layer, intermediate layer, lower layer; daily average value)
Water temperature (upper layer, intermediate layer, lower layer; daily average value)
Salt concentration (upper layer, intermediate layer, lower layer; daily average value)
Dissolved oxygen amount (upper layer, intermediate layer, lower layer; daily average value)
Turbidity (upper layer, intermediate layer, lower layer; daily average value)
Flow rate (upper layer, intermediate layer, lower layer, daily average value and daily total value for each component in the North, South, East and West)

### [Meteorological Data]

Atmospheric temperature (daily average value)
Precipitation (daily average value, daily total value)
Sunshine duration (daily average value, daily total value)
Wind velocity (daily average value and daily total value for each component in the North, South, East and West)

The predictor uses the above 52 items for the previous 1 to 3 days as explanatory variables, and sets the 52 items on day 0 as objective variables. In other words, a number of nodes in the input layer and those in the outer layer are the same, and the prediction models are created for all the variables. A number of nodes in a hidden layer is 100.

For the learning of the predictor, 3 algorithms (Simple RNN, LSTM and GRU) of the recurrent neural network were used, and GRU presented the best prediction. FIG. 7 indicates the result. FIG. 7A indicates the fluctuation of the chlorophyll-a concentration out of the observed data. Of this, 7 years of data was used for the learning data (training data), and the last one year of data was used for the test data (validation data). FIG. 7B is a graph of the prediction result for one day later by the predictor which was learned using GRU, the prediction result is superimposed on the observed data in FIG. 7B. The prediction using the learning data and the observed values approximately match, which means that sufficient learning was performed. The average learning error (RMSE) was 11.97 μg/L. In order to check over-fitting and to evaluate versatility, about one year of test data, which was not used for learning, was fitted into the prediction model, and data for one day later was predicted. The prediction error was 15.29 μg/L, which means that the versatility of prediction is high.

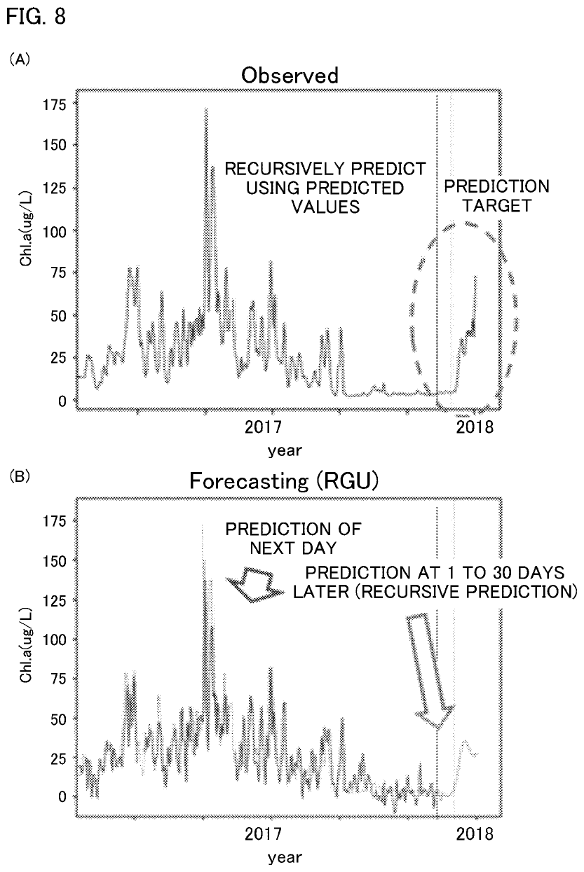

Further, the predicted values were recursively inputted into the prediction model for one day later created like this, whereby long term prediction up to 30 days later was performed. FIG. 8 indicates the result. FIG. 8A indicates the fluctuation of the observed data of chlorophyll-a concentration, just like FIG. 7A, but in FIG. 8A, the period from the latter half of 2017 to mid-January 2018 is enlarged. FIG. 8B indicates the values predicted for 30 days, up to the end of January 2017, by inputting 3 days of observed data at the end of December 2017 to perform prediction for one day later, and recursively inputting the predicted values for one day later into the prediction model. As indicated in FIG. 8B, the predicted values and observed value matched well for about 15 days up to mid-January 2018. This means that the present method is effective for long term prediction.

### ANALYSIS EXAMPLE 2

Next, using the same method as Analysis Example 1, learning and prediction were performed without using the wind velocity data. The data used for the analysis is essentially the same as the Analysis Example 1 described above, but a number of explanatory variables is 44 items, since 8 items related to the wind velocity were removed from the above mentioned 52 items.

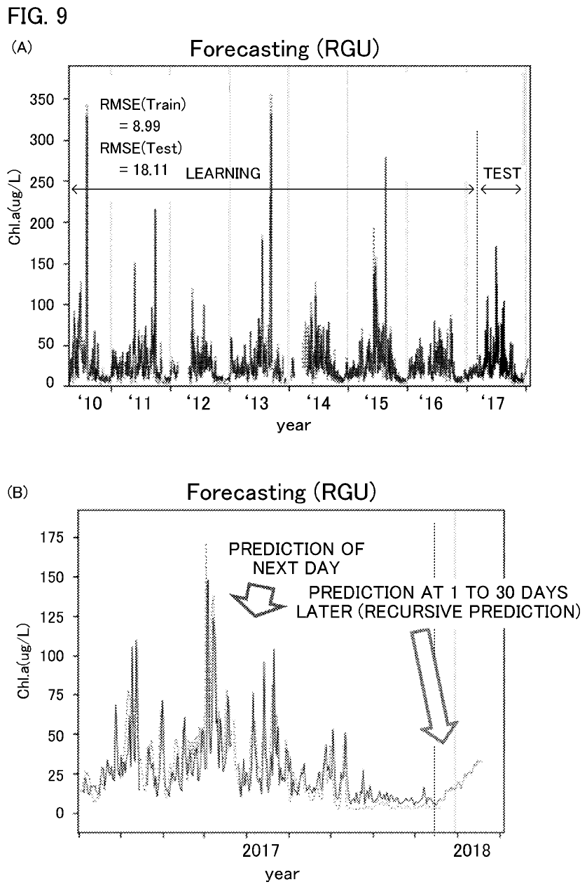

FIG. 9A is a graph when 7 years of observed data was used as the learning data, just like the Analysis Example 1, and the last 1 year of data was used as the test data. The prediction result by the predictor which was learned using a GRU algorithm is superimposed on the observed data in FIG. 9A. The prediction error is 18.11 μg/L, which means that sufficient accuracy was acquired even if the prediction accuracy was lower than Analysis Example 1.

FIG. 9B indicates the result of recursively inputting the predicted values into the created prediction model for one day later, and performed long term prediction up to 30 days later. Just like the Analysis Example 1 (FIG. 8B), FIG. 9B indicates the values predicted for 30 days up to the end of January 2017, by inputting 3 days of observed data at the end of December 2017 to perform prediction for one day later, and recursively inputting the predicted values for one day later into the prediction model. In this way, the rise of chlorophyll-a concentration, generated in mid-January 2018, can be predicted without using the wind velocity data.

### ANALYSIS EXAMPLE 3

In the method described in the Analysis Example 1, sampling data of sea water was also added to perform the learning and prediction. Here, for the sampling data, 7 items including Karenia brevis were used as the microorganism data included in the water sample, 214 items including amino acids and saccharides were used as the organic substrate data, and 20 items including nitrogen, phosphorus and silicon were used as the inorganic substance data. Out of the 52 items of the marine data and meterological data, 33 items were used, since 19 items of daily total values were not used.

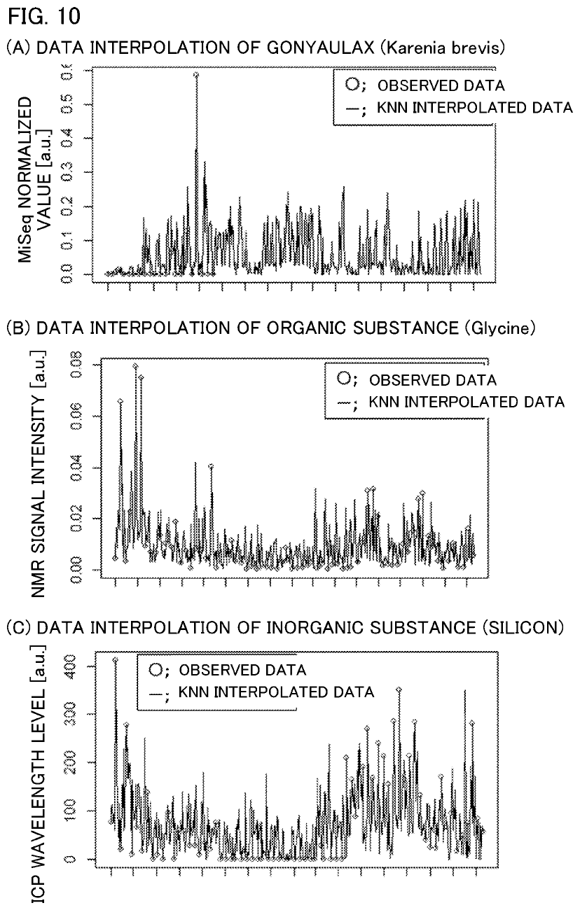

In Analysis Example 3, 3 years of data acquired at Kawasaki Artificial Island were used for learning. For many missing values included in each data, interpolation was performed based on a k-nearest neighbor algorithm (KNN). FIG. 10A to FIG. 10C indicate examples of the observed data and interpolated data of Gonyaulax (marine microorganism), glycine (organic substance) and silicon (inorganic substance). In FIG. 10, O indicates the observed data and the other data is interpolated data. By interpolating the missing values in this way, discrete data is converted into continuous data (daily data) so as to integrate the marine data, meteorological data and sampling data.

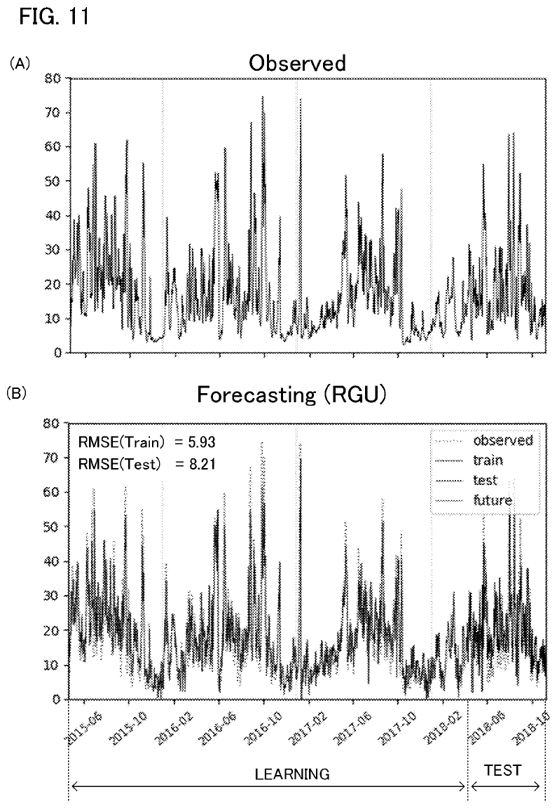

FIG. 11A indicates the fluctuation of the chlorophyll-a concentration out of about 3 and a half years of observed data (from April 2015 to November 2018). Out of this observed data, the first 3 years of data was used for the learning data (training data), and the remainder was used for test data (validation data). FIG. 11B is a graph of the prediction result for one day later by the predictor which was learned using GRU, the prediction result is superimposed on the observation data in FIG. 11B. The learning error was 5.93 μg/L and the prediction error was 8.21 μg/L, which means that a more accurate prediction can be implemented by adding the sampling data.

<Review of Missing Value Interpolation Method>

Since missing values are frequently included in observed data, particularly in sampling data, the missing value interpolation methods were compared and evaluated. Here leave-one-out cross-validation (LOOCV) was performed on the above mentioned 72 days of daily sampling data (microorganisms: 7 items; metabolites: 214 items; elements: 20 items).

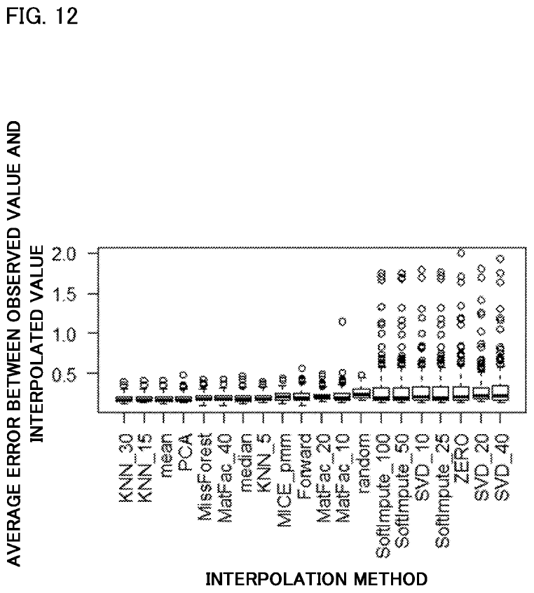

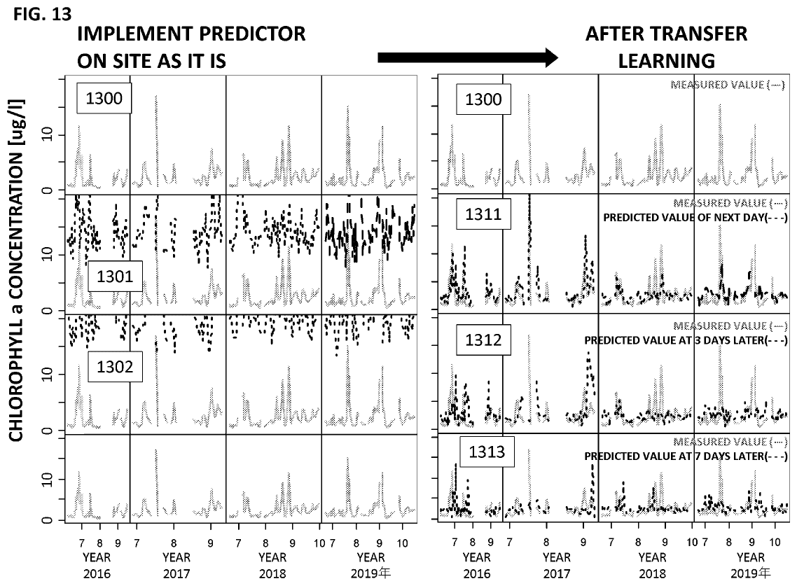

FIG. 12 is a boxplot indicating the errors between the interpolated values and observed values acquired by each interpolation method. A numeric value after the under bar listed in each interpolation method indicates a number of data from which the nearest neighbor distance is determined in the case of KNN, or indicates a number of components into which an eigenvalue is decomposed to generate the interpolation model in the case of Matrix factorization (MatFac), SVD and SoftImpute.

FIG. 12 indicates the methods which are listed in the sequence from a smaller average error (RMSD). In the case of SVD and SoftImpute, which are matrix interpolation methods, there are many items where errors increase, while in the case of machine learning-based interpolation methods, such as KNN and MissForest, errors tend to decrease for all items. Therefore it is preferable to use the machine learning-based interpolation methods, and it is more preferable to use KNN in which K=15 or 30. Interpolation with few errors is possible if the methods from “KNN #30” to “random” indicated in FIG. 12 are used, even if the method s are not a machine learning-based interpolation methods.

<Modification>

In the above description, prediction is performed using daily data, but the interval of acquiring data may be longer or shorter than this. For example, hourly data may be used for learning and prediction.

In the above description, the predictor predicts the data for one day later using 3 days (3 unit times) of data, but may predict the data for one day later using a longer period of data. By increasing a number of days, an improvement in the prediction accuracy can be expected, and especially if the periodicity of data is reflected in the learning, the prediction accuracy can be improved considerably. On the other hand, increasing a number of days to acquire data increases the possibility of generating missing value data, hence a number of days to acquire data is preferably determined considering this aspect as well.

In the above examples, a case of using 2 types of input data (marine observation data 25 and meteorological observation data 26) (FIG. 3), and a case of using 4 types of input data (marine observation data 25, meteorological observation data 26, sampling data 27 and meteorological forecasting data 28) (FIG. 5), were described. However, 3 types of input data (marine observation data 25, meteorological observation data 26 and sampling data 27) may be used, or 3 types of input data (marine observation data 25, meteorological observation data 26 and meteorological forecasting data 28) may be used. The sampling data 27 may include only 1 or only 2 data out of the microorganisms, organic substances and inorganic substances.

In the above mentioned configuration, regional characteristics are not used in the algorithm, hence by using a learned mode based on a learning data (training model) in a certain region, the environmental factors of another region can be predicted. In other words, prediction in an arbitrary region can be performed if a learned mode, that does not use regional characteristics, is acquired. However, the geological elements, characteristic weather of a region, and the like, may be included in the explanatory variables, and in this case, an improvement in the prediction accuracy in a target region can be expected.

In the above description, the generation of red tide is predicted, but the generation of blue tide can also be predicted using the same configuration. The environmental factor prediction method and device may be used to perform processing up to the prediction of chlorophyll-a concentration, without predicting the generation of red tide or blue tide. Further, the generation of water bloom may be predicted using the same configuration as above, and in this case, the water sample is fresh water instead of sea water.

### Embodiment 2

Embodiment 2 is essentially the same as Embodiment 1, except that transfer learning is performed and applied to another region based on the predictor which was learned using the learning data of a certain region.

In Embodiment 1, the geographical characteristics are not used for the explanatory variables, hence the predictor which was learned using learning data of a certain region can be applied to another region. This is effective in that the learning data need not be acquired for each implementation site, but if the predictor is applied directly, the prediction accuracy may drop. Therefore in Embodiment 2, a predictor that is suitable for an implementation site is generated using the transfer learning.

In Embodiment 2, using the method of Embodiment 1, a predictor (learning model) is generated in a region (e.g. Tokyo Bay) where a sufficient volume of learning data can be acquired. This predictor (learning model) may be referred to as a “pre-learned predictor (learning model)”. Then learning data in the implementation site to which the predictor is applied is prepared. The content of the learning data is the same as Embodiment 1. Using the learning data in the implementation site, the learning of the predictor continues to be performed. At this time, the weight of the network of the predictor may be adjusted only for the layer closer to output, while the weight is fixed for the layer close to input. Further, only the weight of the nodes related to the geographical parameters, specifically only the weight of the nodes on which the influence of geographical specificity is large (or estimated to be large) may be adjusted. For example, learning may be performed in advance using learning data at a plurality of locations, so that only a node of which importance changes depending on its location is adjusted. The information on the weight is acquired by calculating the importance of a random forest algorithm in Embodiment 2, but other machine learning algorithms may be used. In Embodiment 2, data on a site is predicted using the predictor acquired by this kind of transfer learning.

FIG. 13 is a diagram for comparing a prediction when a predictor A, which was learned using the learning data on Tokyo Bay without performing the transfer learning, is directly applied to the implementation side (a tuna farm in Imari Bay), with a predictor B, for which transfer learning was performed using the learning data on the implementation site.

A graph 1300 indicates the measured values of the chlorophyll-a concentration at the implementation site. A graph 1301 indicates the predicted values for one day later using the predictor A, and a graph 1302 indicates the predicted values for 3 days later using the predictor A. For comparison, measured values are also indicated in the graph using fine lines. As the graphs indicate, errors between the predicted values and the measured values are large in this example. Since the errors are large on the prediction 3 days later, prediction using the predictor A was not performed for 7 days later.

Graphs 1311 to 1313 are graphs generated by plotting the predicted values for 1 day later, for 3 days later and for 7 days later using the predictor B which was learned by performing transfer learning. As indicated, the prediction accuracy improves by performing the transfer learning. Even in the prediction for 7 days later, the chlorophyll-a concentration can be predicted, that is, the start and end of the generation of red tide can be predicted.

As described above, according to Embodiment 2, the transfer learning is performed based on the predictor which was learned in advance on a region having a high volume of learning data, hence a highly accurate predictor can easily be generated even if the learning data volume in the implementation site is low. In Embodiment 1, parameters directly related to the geographical factors are not used for the explanatory variables, but how each parameter influences the generation of red tide could be changed by geographical influences. In Embodiment 2, the weights among the parameters are adjusted so as to incorporate the specificity of the implementation site by the transfer learning, whereby the prediction accuracy improves.

Further, according to Embodiment 2, important factors can be extracted for each implementation site. A contribution rate of each parameter may be determined for the learning model after performing the transfer learning and the learning model after performing prior learning, so as to output parameters of which the contribution rate is high. For example, in Tokyo Bay, parameters of which the contribution rate is higher are in the sequence of K, S, Ca, Tp, Sr, B, NH₃—N and Na in the case of organic substances/inorganic substances, and are in the sequence of the chlorophyll-a concentration, sunshine duration, pH, water temperature, West wind, East wind, dissolved oxygen amount and South wind in the case of environmental physical parameters. On the other hand, in Imari Bay, parameters of which the contribution rate is higher are in the sequence of Sr, Mg, K, B, Na, S, Ca and Li in the case of organic substances/inorganic substances, and are in the sequence of the North wind, South wind, sunshine duration, West wind, chlorophyll-a concentration, East wind, precipitation and water temperature in the case of the environmental physical parameters. As described above, according to Embodiment 2, important factors in the implementation site can be determined.

### Embodiment 3

In Embodiment 3, meteorological simulation data, marine simulation data and river inflow simulation data are used to predict the generation of red tide. The configuration of the red tide generation device is the same as FIG. 5.

In Embodiment 3, the marine data and meteorological data acquired by observation and data acquired by simulation are used as the explanatory variables, and the marine data and meteorological data for one time step later are predicted as the objective variables.

In the following description, the terms “marine data” and “meteorological data” indicate that the data is either acquired by observation or predicted by the predictor 23, and data acquired by simulation, not using the predictor 23, is referred to as “simulation data”.

First, the input data acquiring unit 21 acquires the marine observation data 25 and meteorological observation data 26 for the most recent predetermined time steps. The input data acquiring unit 21 also acquires the simulation data for the latest predetermined time steps and for the target time steps of the long term forecasting.

The predictor 23 predicts the marine data and meteorological data for one time step later, by inputting the marine data and meteorological data for the latest predetermined time steps, and the simulation data for the latest predetermined time steps and for the target time steps of the long term forecasting. The long term prediction unit 22 predicts the marine data and meteorological data for each time step at a time, up to a predetermined time steps later, using the predicted marine data and meteorological data. The input to the predictor 23 is the marine data, meteorological data and simulation data for a latest predetermined time step.

For the learning of the predictor 23, the same method as Embodiment 1 may be used. The difference, however, is that not only the observed data but the simulation data as well may be used for the learning data.

A specific example of the prediction performed for Tokyo Bay will be described.

In this example, for the marine data, chlorophyll-a concentration, water temperature, salt concentration, dissolved oxygen (DO) amount, turbidity and flow rate (East-West component, South-North component) in the upper layer, intermediate layer and lower layer respectively were used (21 items). For the meteorological data, atmospheric temperature, wind velocity (East-West component, South-North component), precipitation and sunshine duration are used (5 items).

For the marine simulation data, phytoplankton amount, water temperature, salt concentration, East-West flow rate, South-North flow rate, zooplankton amount, ammonia nitrogen and nitrate nitrogen were used (8 items). For the meteorological data, atmospheric temperature (2 m above sea level), precipitation (integrated precipitation for 1 hour from the current time) downward shortwave radiation and downward longwave radiation were used (4 items). For the data of the river inflow simulation, the inflow amounts from the Koito River, Koseki River, Tama River, Tsurumi River, Ara River, Sumida River, Edo River and Hanami River were used (8 items). For the marine simulation, ROMS was used, and for the meteorological simulation, MSM was used.

In this example, 1 time step is 6 hours, and the observed data and simulation data were acquired every 6 hours, and a predictor 23 predicted the marine data and meteorological data for the next time step based on the latest 6 time steps (36 hours). For the learning of the predictor 23, a CNN-QRNN algorithm was used. The long term prediction unit 22 repeats the prediction 6 times using the predictor 23, and predicted the marine data and meteorological data up to 6 time steps later (36 hours later).

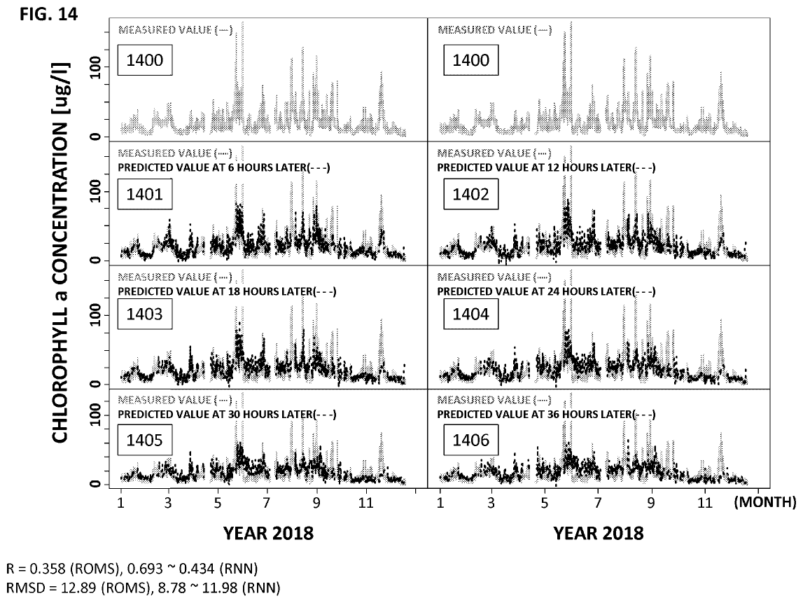

FIG. 14 indicates the measured values of the chlorophyll-a concentration in Tokyo Bay, and the predicted values acquired using the predictor which learned in this example. A graph 1400 indicates the measured values of chlorophyll-a concentration. Graphs 1401 to 1406 indicate the predicted values for 6, 12, 18, 24, 30 and 36 hours later. For comparison, the measured values are also indicated in the graphs using fine lines.

### Embodiment 4

In Embodiment 1 to 3, the amount of photosynthetic microorganisms and chemosynthetic microorganisms, such as plankton and bacteria, are predicted to predict the generation of red tide, blue tide and water bloom. This technique can be used not only to predicting the generation of red tide, blue tide and water bloom, but also for predicting the generation of diseases of fish. In this case, it is necessary to include parameters, which indicate the amount of pathogens (causative substances) that cause the diseases, in the marine data (water quality data).

An example of these diseases is vibriosis. Vibriosis is a generic term for the infectious diseases caused by the pathogens of vibrio bacteria. The amount of vibrio bacteria can be measured by a host specific DNA sequence. If the pathogen is a protoctist, the amount of the pathogens can be measured by a specific DNA sequence. And if the pathogen is a virus, the amount of the pathogen can be measured by a specific RNA or DNA sequence.

Further, by measuring the absorbance, the qualitative and quantitative analysis of biological samples, such as nucleic acid, which is constituted of DNA and RNA, and protein, can be performed. Thereby the total amount of bacteria, viruses, protoctists, and the like, in water can be qualitatively and quantitatively determined. Specifically, environmental water, such as sea water and lake water, is collected and prepared as samples using a filter or the like, and the absorbance is measured. The qualitative and quantitative values of the viruses acquired by the absorbance measurement are equivalent to the value corresponding to the biochrome level or the bioluminescence level.

Embodiment 4 may be combined with any one of Embodiments 1 to 3.

### REFERENCE SIGNS LIST

10 Learning device
11 Learning data acquiring unit
12 Pre-processing unit
13 Learning unit
20 Red tide prediction device
21 Input data acquiring unit
22 Long term prediction unit
23 Predictor
24 Forecasting unit

1. An environmental factor prediction device, comprising:
a predictor that uses, as explanatory variables, water quality data in a plurality of layers in water, the data including a value corresponding to a biochrome level or a bioluminescence level, water temperature, salt concentration, dissolved oxygen, turbidity and flow rate, and meteorological data including atmospheric temperature, precipitation and sunshine duration, and that outputs an estimated value of each item of the explanatory variables at a unit time later, based on time series data of the explanatory variables;
predicting unit configured to predict the water quality data up to an N unit time later (N is 2 or greater integer) by repeating prediction using the estimated value acquired by the predictor as input of the predictor again.

2. The environmental factor prediction device according to claim 1, wherein the water quality data includes chlorophyll concentration as a value corresponding to a biochrome level.

3. The environmental factor prediction device according to claim 1, wherein the meteorological data further includes wind velocity.

4. The environmental factor prediction device according to claim 1, wherein the explanatory variables include data on at least any of microorganisms, organic substances and inorganic substances, sampled from a water sample.

5. The environmental factor prediction device according to claim 1, further comprising forecasting unit configured to forecast generation of red tide, blue tide or water bloom, based on a value corresponding to the biochrome level or the bioluminescence level, predicted by the predicting unit.

6. The environmental factor prediction device according to claim 5, wherein the forecasting unit forecasts the start or end of the red tide.

7. The environmental factor prediction device according to claim 5, wherein the forecasting means forecasts the start or end of the blue tide.

8. The environmental factor prediction device according to claim 5, wherein the forecasting unit forecasts the start or end of the water bloom.

9. The environmental factor prediction device according to claim 5,
wherein the explanatory variables of the predictor further include microorganism data related to microorganisms contained in water, and
wherein the forecasting unit forecasts dominant planktonic species or dominant bacterial species in the red tide, the blue tide or the water bloom, of which generation is predicted, based on the microorganism data predicted by the predicting unit.

10. The environmental factor prediction device according to claim 9, wherein the forecasting unit forecasts the start or end of the generation of the red tide, the blue tide or the water bloom by using a criterion value corresponding to the dominant planktonic species or the dominant bacterial species.

11. The environmental factor prediction device according to claim 1, wherein the predicting unit corrects estimated values of the meteorological data or the water quality data, which are acquired from the predictor, based on meteorological forecasting data or the water quality forecasting data, which is acquired via simulation that is different from the predictor, and which are then inputted to the predictor.

12. The environmental factor prediction device according to claim 1, wherein the predictor is learned by machine learning.

13. The environmental factor prediction device according to claim 1, wherein the predictor is acquired by learning a learning model, which has been learned using first learning data based on observed values of the water quality data and the meteorological data in a first region, via transfer learning using second learning data based on observed values of the water quality data and the meteorological data in a second region.

14. An environmental factor prediction method, comprising:
a first step of acquiring time series data of explanatory variables, which are water quality data in a plurality of layers in water, the data including a value corresponding to a biochrome level or a bioluminescence level, water temperature, salt concentration, dissolved oxygen, turbidity and flow rate, and meteorological data including atmospheric temperature, precipitation and sunshine duration;
a second step of acquiring an estimated value of each item of the explanatory variables at a unit time later of the time series data acquired in the first step, using a predictor to output an estimated value of each item of the explanatory variables at a unit time later, based on the time series data of the explanatory variables; and
a third step of predicting the water quality data up to an N unit time later (N is 2 or greater integer) by repeating the processing in the second step using the estimated value acquired in the second step as input of the predictor again.

15. A non-transitory computer readable medium storing a program causing a computer to execute each of the steps according to claim 14.

16-17. (canceled)

18. An environmental factor prediction device, comprising:
a predictor that uses, as explanatory variables, water quality data including a value corresponding to an amount of pathogens that become a cause of diseases of fish, and meteorological data, and that outputs an estimated value of each item of the explanatory variables at a unit time later, based on time series data of the explanatory variables; and
predicting unit configured to predict the water quality data up to an N unit time later (N is 2 or greater integer) by repeating prediction using the estimated value acquired by the predictor as input of the predictor again.

19. The environmental factor prediction device according to claim 18, wherein
the predictor is acquired by learning a learning model, which has been learned using first learning data based on observed values of the water quality data and the meteorological data in a first region, via transfer learning using second learning data based on observed values of the water quality data and the meteorological data in a second region, and
in the transfer learning, a weight of a node related to geographical parameters is adjusted.

20. The environmental factor prediction device according to claim 18, wherein
the predictor outputs an estimated value of each item of the water quality data and the meteorological data at a unit time later, based on the time series data of the water quality data, the meteorological data and simulation data of at least one of water quality and meteorological phenomena, and
the predicting unit acquires the simulation data up to an N unit time later, and predicts the water quality data up to an N unit time later by repeating prediction using: the predicted values of the water quality data and the meteorological data acquired by the predictor; and at least a part of the acquired simulation data, as input.

21. The environmental factor prediction device according to claim 18, wherein
the diseases of fish are due to the red tide, the blue tide or the water bloom, and
the value corresponding to the amount of the pathogens is a value corresponding to the biochrome level or the bioluminescence level.
